(19) United States
(12) Patent Application Publication
(10) Pub. No.: US 2026/0122474 A1
(43) Pub. Date: Apr. 30, 2026

(54) Subscription Management in a Wireless Communication Network

(71) Applicant: Telefonaktieblaget LM Ericsson (publ), Stockholm (SE)

(72) Inventors: Abu Shohel Ahmed, Espoo (FI); Patrik Salmela, Espoo (FI); Kazi Wali Ullah, Espoo (FI); George Zhou, Guangzhou (CN)

(21) Appl. No.: 18/550,725

(22) PCT Filed: Aug. 23, 2021
(86) PCT No.: PCT/EP2021/073304

§ 371 Date: Sep. 15, 2023

(30) Foreign Application Priority Data
Mar. 24, 2021 (WO) PCT/CN2021/082679

(51) Int. Cl. H04W 8/20; H04M 15/00

(52) U.S. Cl. CPC H04W 8/20; H04M 15/41

(57) ABSTRACT

Network equipment (34) is configured for use in a first wireless communication network (30). The network equipment (34) receives, from a second wireless communication network (20), subscription data (20D*) for a subscription (20S) to the second wireless communication network (20). The network equipment (34) creates, based on the received subscription data (20D*), a subscription (30S) to the first wireless communication network (30). In some embodiments, the network equipment (34) furthermore transmits information associated with the created subscription (30S) to wireless communication equipment (10) that is to be provided wireless communication service from the first wireless communication network (30) according to the created subscription (30S).

### TECHNICAL FIELD

The present application relates generally to a wireless communication network, and relates more particularly to subscription management in such a wireless communication network.

### BACKGROUND

A subscriber that has a subscription to a wireless communication network is able to receive wireless communication service from that network. This so-called “home” network of the subscriber, though, may have limited wireless coverage. If the subscriber were to roam away from the home network's wireless coverage area, the home network would not be able to serve the subscriber. The home network's operator may however have a roaming agreement with the operator of another network which does have wireless coverage where the subscriber has roamed. According to the roaming agreement, the so-called “visited” network to which the subscriber has roamed provides wireless communication service to the subscriber on the basis that the subscriber has a subscription to the home network. That is, the visited network provides wireless communication service to the home network's subscriber, even though the subscriber does not have a subscription to the visited network.

Although roaming agreements facilitate seamless wireless communication service beyond the wireless coverage area of any single network, the extra amount that a subscriber must pay to receive service while roaming varies significantly from country to country and operator to operator. In these and other cases, then, challenges exist in how to provide wireless communication service to a subscriber in a way that is cost-effective and convenient for a subscriber.

### SUMMARY

Some embodiments herein create a subscription to one wireless communication network based on data for a subscription to another wireless communication network. For example, when a subscriber to a home network visits a visited network while roaming away from his or her home network, the visited network may create for the subscriber a subscription to the visited network from data for the subscriber's subscription to the home network. The subscriber can then receive wireless communication service from the visited network directly on the basis of the created subscription to the visited network, instead of or in addition to receiving wireless communication service from the visited network on the basis of any roaming agreement between the home and visited networks. In doing so, some embodiments advantageously provide wireless communication service to a subscriber in a way that is more cost-effective and convenient for the subscriber.

More particularly, embodiments herein include a method performed by network equipment in a first wireless communication network. The method comprises receiving, from a second wireless communication network, subscription data for a subscription to the second wireless communication network. The method also comprises creating, based on the received subscription data, a subscription to the first wireless communication network. The method also comprises transmitting information associated with the created subscription to wireless communication equipment that is to be provided wireless communication service from the first wireless communication network according to the created subscription.

In some embodiments, according to the subscription to the second wireless communication network, the second wireless communication network is a home network and the first wireless communication network is a visited network.

In some embodiments, the subscription data includes an equipment identifier that identifies the wireless communication equipment.

In some embodiments, the subscription data includes an identifier of, or a pointer to, the subscription to the second wireless communication network.

In some embodiments, the subscription data includes personally identifiable information of a subscriber that owns the subscription to the second wireless communication network. In some embodiments, the subscription data excludes personally identifiable information of a subscriber that owns the subscription to the second wireless communication network. In one or more of these embodiments, the personally identifiable information includes billing information usable to directly bill a subscriber for the subscription to the second wireless communication network. Additionally or alternatively, the personally identifiable information includes a name of and/or address of a subscriber that owns the subscription to the second wireless communication network.

In some embodiments, creating a subscription to the first wireless communication network comprises forming subscription data for the subscription to the first wireless communication network and storing the formed subscription data in a subscription data store for the first wireless communication network. In this case, the subscription data for the subscription to the first wireless communication network includes at least some of the received subscription data for the subscription to the second wireless communication network.

In some embodiments, creating a subscription to the first wireless communication network comprises transmitting, to subscription manager data preparation equipment, an order for a profile for the subscription to the first wireless communication network. In this case, the information associated with the created subscription includes information usable to retrieve the profile from the subscription manager data preparation equipment.

In some embodiments, the method further comprises receiving information indicating a subscription plan to be associated with the subscription to the first wireless communication network. In this case, the subscription plan defines one or more of one or more services to be provided under the subscription to the first wireless communication network and a billing policy according to which the subscription to the first wireless communication network is to be billed. In some embodiments, the subscription to the first wireless communication network is created according to the indicated subscription plan.

In some embodiments, the method further comprises transmitting, to the second wireless communication network, subscription data for the created subscription to the first wireless communication network.

In some embodiments, the method further comprises transmitting a request from the network equipment in the first wireless communication network to the second wireless communication network. In this case, the request is a request for the subscription data for the subscription to the second wireless communication network or is a request for assistance with creating the subscription to the first wireless communication network. Also in this case, the request includes a subscription identifier that identifies the subscription to the second wireless communication network, and the subscription data for the subscription to the second wireless communication network is received in response to transmitting the request.

Other embodiments herein include a method for assisting a first wireless communication network with subscription management. The method is performed by network equipment in a second wireless communication network. The method comprises checking whether or not subscription data for a subscription to the second wireless communication network is allowed to be used for creating a subscription to the first wireless communication network, and if the subscription data is allowed to be used according to said checking, transmitting the subscription data from the second wireless communication network to the first wireless communication network.

In some embodiments, the second wireless communication network is a home network for the subscription to the second wireless communication network. In one such embodiment, the first wireless communication network is a visited network for the subscription to the second wireless communication network.

In some embodiments, the subscription data includes an equipment identifier that identifies the communication equipment.

In some embodiments, the subscription data includes an identifier of, or a pointer to, the subscription to the second wireless communication network.

In some embodiments, the subscription data includes personally identifiable information of a subscriber that owns the subscription to the second wireless communication network. In some embodiments, the subscription data excludes personally identifiable information of a subscriber that owns the subscription to the second wireless communication network. In one or more of these embodiments, the personally identifiable information includes billing information usable to directly bill a subscriber for the subscription to the second wireless communication network. Additionally or alternatively, the personally identifiable information includes a name of and/or address of a subscriber that owns the subscription to the second wireless

In some embodiments, the method further comprises receiving, from the first wireless communication network, subscription data for the subscription to the first wireless communication network, and using the received subscription data to configure billing and/or communication service for the subscription to the second wireless communication network. In one or more of these embodiments, the received subscription data includes a Mobile Station International Subscriber Directory Number, MSISDN, for the subscription to the first wireless communication network. In one embodiment, using the received subscription data comprises configuring call forwarding from an MSISDN for the subscription to the second wireless communication network to the MSISDN for the subscription to the first wireless communication network.

In some embodiments, the method further comprises receiving a request that is either a request for the subscription data for the subscription to the second wireless communication network or a request for assistance with creating the subscription to the first wireless communication network. In this case, the request includes a subscription identifier that identifies the subscription to the second wireless communication network, and checking whether or not subscription data for a subscription to the second wireless communication network is allowed to be used for creating a subscription to the first wireless communication network is performed responsive to receipt of the request.

In some embodiments, the method further comprises receiving, from communication equipment associated with the subscription to the second wireless communication network, information indicating a subscription plan to be associated with the subscription to the first wireless communication network. In this case, the subscription plan defines one or more of one or more services provided under the subscription to the first wireless communication network and a billing policy according to which the subscription to the first wireless communication network is billed. The method further comprises transmitting the received information to the first wireless communication network.

Other embodiments herein include a method performed by communication equipment. The method comprises transmitting, from the communication equipment, a request that subscription data for a subscription to a second wireless communication network be used for creating a subscription to a first wireless communication network.

In some embodiments, the method further comprises retrieving, from subscription manager data preparation equipment, a profile for the subscription to the first wireless communication network created according to the request and configuring the communication equipment with the retrieved profile.

In some embodiments, the method further comprises receiving wireless communication service from the first wireless communication network according to the subscription to the first wireless communication network.

In some embodiments, the method further comprises transmitting, from the communication equipment to the first wireless communication network or to the second wireless communication network, information indicating a subscription plan to be associated with the subscription to the first wireless communication network. In this case, the subscription plan defines one or more of one or more services provided under the subscription to the first wireless communication network and a billing policy according to which the subscription to the first wireless communication network is billed.

In some embodiments, the method further comprises using the subscription to the first wireless communication network for communication initiated by the communication equipment or wireless communication equipment associated with the communication equipment. The method further comprises using the subscription to the first wireless communication network for monitoring for communication initiated by the first wireless communication network, and using the subscription to the second wireless communication network for monitoring for communication initiated by the second wireless communication network.

Other embodiments herein include network equipment configured for use in a first wireless communication network. The network equipment is configured to receive, from a second wireless communication network, subscription data for a subscription to the second wireless communication network, create, based on the received subscription data, a subscription to the first wireless communication network, and transmit information associated with the created subscription to communication equipment that is to be provided wireless communication service from the first wireless communication network according to the created subscription.

Other embodiments herein include network equipment configured for assisting a first wireless communication network with subscription management. The network equipment is configured for use in a second wireless communication network and is configured to check whether or not subscription data for a subscription to the second wireless communication network is allowed to be used for creating a subscription to the first wireless communication network. The network equipment is also configured to, if the subscription data is allowed to be used according to said checking, transmit the subscription data from the second wireless communication network to the first wireless communication network.

In some embodiments, the network equipment is configured to perform the steps described above for network equipment in a second wireless communication network.

Other embodiments herein include communication equipment configured to transmit, from the communication equipment, a request that subscription data for a subscription to a second wireless communication network be used for creating a subscription to a first wireless communication network.

Other embodiments herein include a computer program comprising instructions which, when executed by at least one processor of network equipment, causes the network equipment to perform the steps described above for network equipment. Other embodiments herein include a computer program comprising instructions which, when executed by at least one processor of communication equipment, causes the communication equipment to perform the steps described above for communication equipment. In one or more of these embodiments, a carrier containing the computer program described above is one of an electronic signal, optical signal, radio signal, or computer readable storage medium.

Other embodiments herein include network equipment configured for use in a first wireless communication network. The network equipment comprises communication circuitry and processing circuitry. The processing circuitry is configured to receive, from a second wireless communication network, subscription data for a subscription to the second wireless communication network. The processing circuitry is also configured to create, based on the received subscription data, a subscription to the first wireless communication network, and transmit information associated with the created subscription to communication equipment that is to be provided wireless communication service from the first wireless communication network according to the created subscription.

In some embodiments, the processing circuitry is configured to perform the steps described above for network equipment.

Other embodiments herein include network equipment configured for assisting a first wireless communication network with subscription management. The network equipment is configured for use in a second wireless communication network and comprises communication circuitry and processing circuitry. The processing circuitry is configured to check whether or not subscription data for a subscription to the second wireless communication network is allowed to be used for creating a subscription to the first wireless communication network. If the subscription data is allowed to be used according to said checking, the processing circuitry is configured to transmit the subscription data from the second wireless communication network to the first wireless communication network.

In some embodiments, the processing circuitry is configured to perform the steps described above for network equipment in a second wireless communication network.

Other embodiments herein include communication equipment comprising communication circuitry and processing circuitry. The processing circuitry is configured to transmit, from the communication equipment, a request that subscription data for a subscription to a second wireless communication network be used for creating a subscription to a first wireless communication network.

In some embodiments, the processing circuitry is configured to perform the steps described above for communication equipment.

Of course, the present invention is not limited to the above features and advantages.

Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of wireless communication networks according to some embodiments.

FIG. 2 is a block diagram of network equipment in a wireless communication network according to some embodiments.

FIG. 3A is a call flow diagram for subscription localization according to some embodiments.

FIG. 3B is a call flow diagram for subscription localization according to other embodiments.

FIG. 4 is a call flow diagram for subscription localization according to still other embodiments.

FIG. 5 is a logic flow diagram of a method performed by network equipment in a first wireless communication network according to some embodiments.

FIG. 6 is a logic flow diagram of a method performed by network equipment in a second wireless communication network according to some embodiments.

FIG. 7 is a logic flow diagram of a method performed by communication equipment according to some embodiments.

FIG. 8 is a block diagram of communication equipment according to some embodiments.

FIG. 9 is a block diagram of network equipment according to some embodiments.

FIG. 10 is a block diagram of a wireless communication network according to some embodiments.

FIG. 11 is a block diagram of a user equipment according to some embodiments.

FIG. 12 is a block diagram of a virtualization environment according to some embodiments.

### DETAILED DESCRIPTION

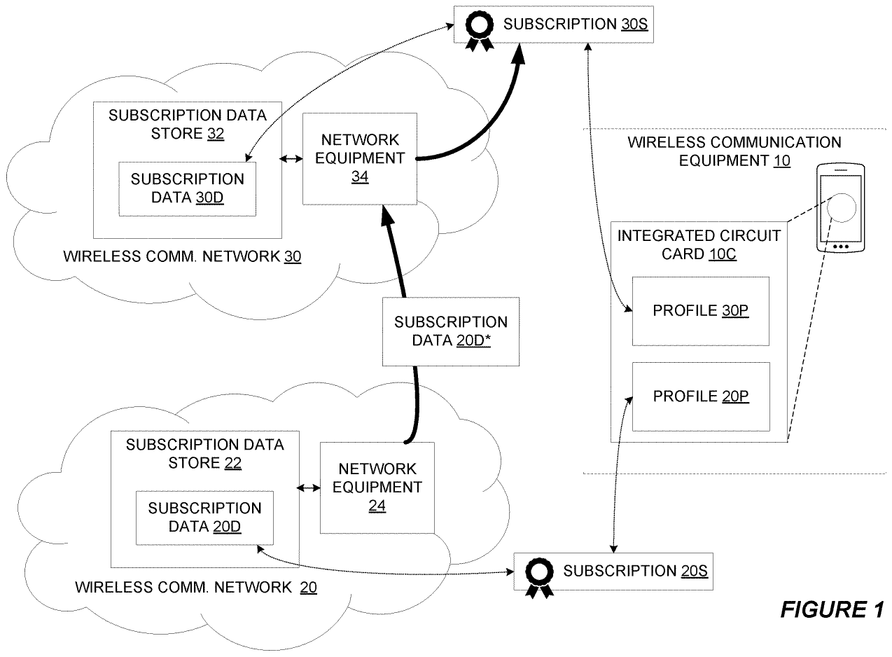

FIG. 1 shows wireless communication equipment 10 according to some embodiments. Wireless communication equipment 10 is configured to receive wireless communication service from wireless communication (comm.) network 20 on the basis of a subscription 20S to that network 20.

As shown in this regard, wireless communication equipment 10 includes an integrated circuit card 10C, e.g., an Embedded Universal Integrated Circuit Card (eUICC). The integrated circuit card 10C has stored thereon a profile 20P for the subscription 20S to wireless communication network 20. Where the integrated circuit card 10C implements a Universal Subscriber Identity Module (USIM), for instance, the profile 20P may be a USIM profile. Regardless, the profile 20P may include a subscription identifier that identifies the subscription 20S (e.g., in the form of an International Mobile Subscriber Identity, IMSI), include an equipment identifier that identifies wireless communication equipment 10, include a long-term cryptographic key (K) specific to the subscription 20S, and/or include other information required to receive service on the basis of the subscription 20S. Wireless communication network 20 as shown stores, in a subscription data store 22, corresponding subscription data 20D for the subscription 20S. This subscription data 20D may for example include the subscription identifier, the equipment identifier, and/or the long-term cryptographic key, as well as personally identifiable information of a subscriber that owns the subscription 20S. Such personally identifiable information may include, among other things, a name of the subscriber, an address of the subscriber, and/or billing information (e.g., credit card information) usable to directly bill the subscriber for the subscription 20S.

Some embodiments herein exploit at least a portion of this subscription data 20D as the basis on which to create a subscription 30S to another wireless communication network; namely, wireless communication network 30. More particularly, network equipment 24 in wireless communication network 20 transmits subscription data 20D* to network equipment 34 in wireless communication network 30, where the transmitted subscription data 20D* includes at least a portion of the subscription data 20D stored in wireless communication network 20. Network equipment 34 then creates, based on the subscription data 20D* received, a subscription 30S to wireless communication network 30. As part of or after creating the subscription 30S, network equipment 34 initiates, controls, or otherwise facilitates provisioning of wireless communication network 30 and/or wireless communication equipment 10 so that the wireless communication equipment 10 can receive wireless communication service from wireless communication network 30 on the basis of the subscription 30S. This may involve, for instance, provisioning wireless communication network 30 with subscription data 30D for the created subscription 30S and/or provisioning wireless communication equipment 10 with a profile 30P for the created subscription 30S. Regardless, wireless communication network 20 according to embodiments herein effectively shares subscription data 20D* with wireless communication network 30 so as to enable wireless communication network 30 to serve wireless communication equipment 10 on the basis of a subscription 30S local to wireless communication network 30.

Some embodiments may accordingly prove advantageous for providing wireless communication service to a subscriber when that subscriber roams away from the wireless coverage area of the subscriber's home network. In some embodiments, for example, wireless communication network 20 is the home network of a subscriber that owns the subscription 20S to wireless communication network 20. If wireless communication network 20 has a roaming agreement with wireless communication network 30, wireless communication network 30 would be accessible to the subscriber as a visited network (according to the subscription 20S to wireless communication network 20). In this case, if the subscriber were to roam to wireless communication network 30, wireless communication network 30 could provide wireless communication service to the subscriber's wireless communication equipment 10 on the basis of the roaming agreement and the subscriber's subscription 20S to wireless communication network 20. According to embodiments herein, though, wireless communication network 30 may alternatively or additionally exploit subscription data 20D* from wireless communication network 20 in order to create a subscription 30S local to wireless communication network 30. This way, instead of or in addition to providing wireless communication service to the wireless communication equipment 10 on the basis of a roaming agreement and the subscription 20S to wireless communication network 20, wireless communication network 30 may provide wireless communication service to the wireless communication equipment 10 on the basis of the local subscription 30S to wireless communication network 30. With service provided on the basis of the local subscription 30S, rather than or in addition to the roaming agreement, roaming charges incurred by the subscriber may be eliminated or reduced so as to prove more cost-effective for the subscriber. Additionally, with service provided on the basis of the local subscription 30S, traffic to or from the wireless communication equipment 10 is routed in a way that is more optimal than if the service were provided on the basis of a roaming subscription 20S, e.g., traffic destined to the Internet is routed directly from wireless communication network 30 to the Internet rather than being routed from wireless communication network 30 to wireless communication network 20 and only then to the Internet. Moreover, the cooperation between the wireless communication networks 20, 30 for sharing of subscription data 20D* advantageously enables the local subscription 30S to be created in a way that is convenient for the subscriber, e.g., the subscriber may be able to get a local subscription to a roaming partner of the subscriber's home network quickly without having to manually provide any information to the roaming partner. Some embodiments may thereby advantageously provide wireless communication service to a roaming subscriber in a way that is more cost-effective and convenient for the subscriber.

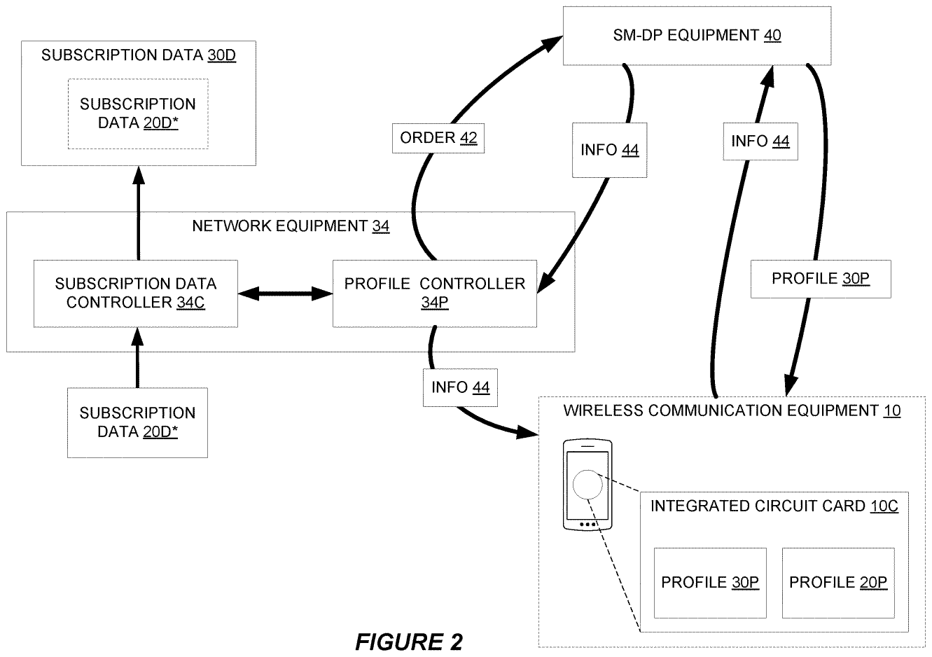

FIG. 2 shows additional details about how wireless communication network 30 and/or wireless communication equipment 10 may be provisioned for use of the subscription 30S to wireless communication network 30. With regard to provisioning of the wireless communication equipment 10, receipt of subscription data 20D* from wireless communication network 20 triggers the network equipment 34 to order the creation of a profile 30P for the subscription 30S. Network equipment 34 in this regard includes a profile controller 34P that transmits, to subscription manager data preparation (SM-DP) equipment 40, an order 42 for a profile 30P for the subscription 30S to wireless communication network 30. In some embodiments, this order 42 includes an equipment identifier that identifies the wireless communication equipment 10 as being the target for the ordered profile. In this case, the network equipment 34 may obtain the equipment identifier from the wireless communication equipment 10 itself or from within the received subscription data 20D*. The order 42 may alternatively or additionally include information about the subscription 30S for which the profile 30P is to be generated, e.g., a subscription plan selected by the subscriber to be associated with the subscription 30S, where the subscription plan defines the subscribed service(s) and/or billing policy for the subscription 30S. Alternatively or additionally, the order 42 may include part(s) of the profile 30P to be generated by the SM-DP equipment 40, e.g., IMSI could be selected and sent by wireless communication network 30 to the SM-DP equipment 40. Regardless, the SM-DP equipment 40 generates the requested profile 30P and transmits a response that includes information (info) 44 associated with the subscription 30S, e.g., in the form of a profile identifier and/or an activation code. This information 44 may for instance be usable to retrieve the profile 30P from the SM-DP equipment 40. Regardless, the profile controller 34P correspondingly transmits this information 44 to the wireless communication equipment 10, either directly or via wireless communication network 20. The wireless communication equipment 10 in some embodiments uses this information 44 to retrieve the profile 30P from the SM-DP equipment 40. The wireless communication equipment 10 may then provision the integrated circuit card 10C with the profile 30P in order to receive wireless communication service from wireless communication network 30. In some embodiments, only one profile may be active on the integrated circuit card 10C at a time, in which case the wireless communication equipment 10 may deactivate or uninstall the profile 20P for wireless communication network 20 in order to activate the profile 30P for wireless communication network 30.

With regard to provisioning of wireless communication network 30, receipt of subscription data 20D* from wireless communication network 20 triggers the network equipment 34 to form subscription data 30D for the subscription 30S to wireless communication network 30. Network equipment 34 in this regard includes a subscription data controller 34C that forms the subscription data 30D, e.g., to include at least some of the subscription data 20D* received from wireless communication network 20. Network equipment 34 then stores the formed subscription data 30D in a subscription data store 32 for wireless communication network 30, e.g., in the form of a Unified Data Management (UDM) function.

The subscription data 20D* that forms the basis for creation of the subscription 30S to wireless communication network 30 may include any type(s) of data that describe or are associated with the subscription 20S to wireless communication network 20. In some embodiments, the subscription data 20D* includes data sufficient in amount and/or character to enable the network equipment 34 to form subscription data 30D that is complete on its own, e.g., for the purpose of identifying, billing, and/or analytically tracking the subscriber for the subscription 30S without regard to the subscriber's subscription 20S to wireless communication network 20. For example, in some embodiments, the subscription data 20D* includes personally identifiable information (PII) of the subscriber that owns the subscription 20S to wireless communication network 20, e.g., as previously verified by wireless communication network 20. The PII may for instance include billing information (e.g., credit card information) usable to directly bill the subscriber for the subscription 20S and/or include a name of and/or address of the subscriber that owns the subscription 20S. In this case, then, forming the subscription data 30D for the subscription 30S to wireless communication network 30 to include such PII enables the operator of wireless communication network 30 to likewise directly identify, bill, and/or analytically track the subscriber for the subscription 30S, e.g., so as to comply with regulatory requirements for creating the subscription 30S. The operator of wireless communication network 30 may thereby retain control over the billing frequency and amount, as well as have the ability to charge an initial reservation amount to verify the received billing information.

In some embodiments, though, the network equipment 34 nonetheless stores a verifiable record (e.g., within subscription data 30D) indicating that wireless communication network 20 provided the subscription data 20D* based on which the subscription 30S was created, e.g., to hold the operator of wireless communication network 20 accountable for the accuracy of that subscription data 20D*. The network equipment 34 may for instance require that wireless communication network 20 digitally sign the subscription data 20D* and retain that digital signature as the verifiable record that the subscription data 20D* originated from wireless communication network 20.

In other embodiments, the subscription data 20D* excludes any such PII. In this case, the subscription data 20D* may include only the minimum data needed to associate the subscription 30S to wireless communication network 30 with the subscription 20S to wireless communication network 20. The subscription data 20D* may for example simply include an identifier of the subscription 20S to wireless communication network 20. Such identifier may for instance be an International Mobile Subscriber Identity (IMSI) or any other identifier uniquely assigned by wireless communication network 20 to the subscription 20S, so that inclusion of the identifier in the subscription data 30D links or associates the subscription 30S to wireless communication network 30 with the subscription 20S to wireless communication network 20. Alternatively in this regard, the subscription data 20D* may just include a pointer to the subscription 20S to wireless communication network 20, e.g., where the pointer is an address, uniform resource locator, pseudorandom number, or other data structure that wireless communication network 20 understands as pointing to the subscription 20S. In any event, by forming the subscription data 30D for the subscription 30S to wireless communication network 30 to include an identifier of, or pointer to, the subscription 20S to wireless communication network 20, the subscription 30S to wireless communication network 30 may be indirectly linked to the subscriber via the subscription 20S to wireless communication network 20. The operator of wireless communication network 30 may correspondingly identify and/or bill the subscriber via the operator of wireless communication network 20.

Embodiments such as this advantageously help protect the subscriber's privacy because wireless communication network 20 keeps the subscriber's PII to itself. In these embodiments, though, the operators of wireless communication networks 20, 30 trust one another. In particular, the operator of wireless communication network 20 trusts the operator of wireless communication network 30 to report real and accurate data regarding the subscriber's use of wireless communication service from wireless communication network 30. And the operator of wireless communication network 30 trusts the operator of wireless communication network 20 to pay for the reported use. In any event, as a convenience for the subscriber, the operator of wireless communication network 20 may bill the subscriber for the subscriber's use of wireless communication network 30, e.g., on the same or different bill as the subscriber's bill for use of wireless communication network 20.

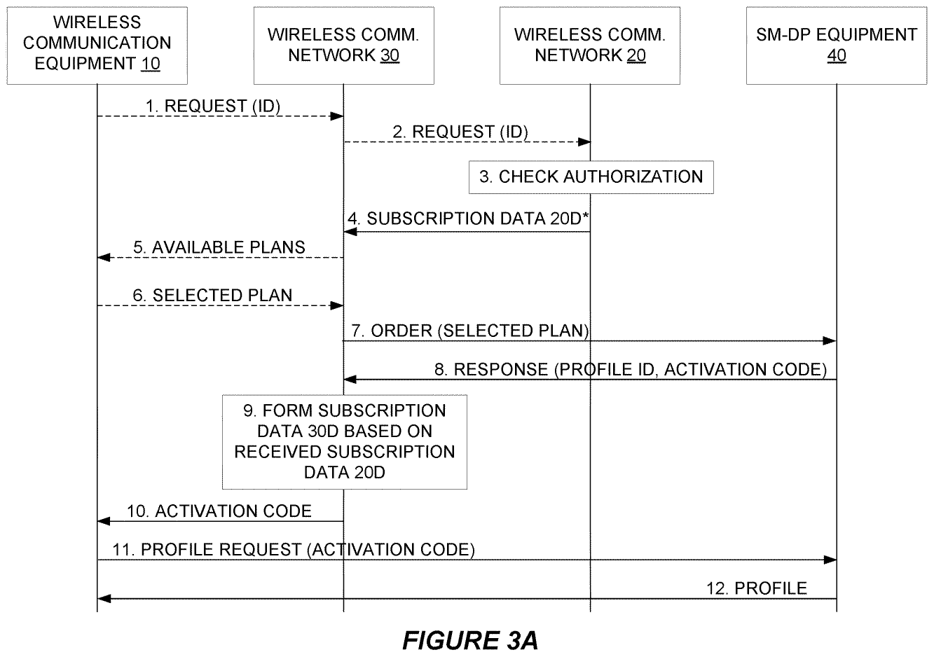

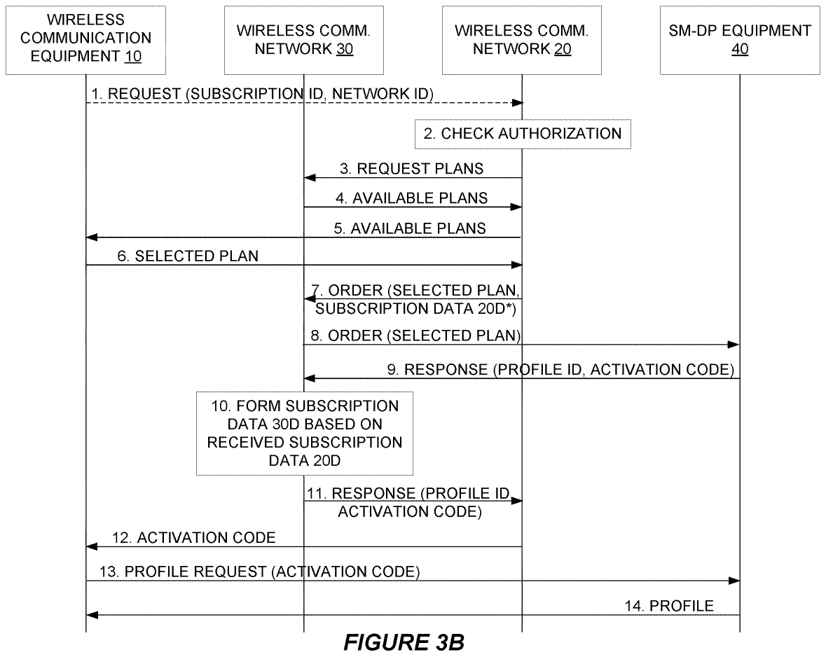

Note that either of the wireless communication networks 20, 30 may interface with the wireless communication equipment 10 for the purpose of initiating creation of the subscription 30S to wireless communication network 30. FIG. 3A illustrates one example where wireless communication network 20 interfaces with the wireless communication equipment 10 in this regard.

As shown in FIG. 3A, the wireless communication equipment 10 in some embodiments transmits a request to wireless communication network 30 (Step 1). This request may for instance be an explicit request that subscription data 20D for the subscription 20S to wireless communication network 20 be used for creating a subscription 30S to wireless communication network 30. Or the request may simply be a request for service from wireless communication network 30. Either way, the request in some embodiments includes an identifier (ID) that identifies the subscription 20S to wireless communication network 20, e.g., as the basis for requesting the creation of a subscription 30S to wireless communication network 30.

In some embodiments, the subscriber as the user of the wireless communication equipment 10 initiates transmission of the request to wireless communication network 30 in Step 1. For example, the wireless communication equipment 10 in some embodiments has an application installed thereon which allows the subscriber to manually select an option to trigger transmission of the request to wireless communication network 30. Alternatively or additionally, the wireless communication equipment 10 may be configured to automatically transmit the request to wireless communication network 30, e.g., on the basis of wireless communication network 30 being a visited network to which the subscription 20S is allowed to roam. For example, the wireless communication equipment 10 may be configured to automatically transmit the request upon attachment to and/or registration with wireless communication network 30 on the basis of the subscription 20S to wireless communication network 20. That is, the wireless communication equipment 10 may first attach to and register with wireless communication network 30 on the basis of the subscriber's subscription 20S to wireless communication network 20, but then request the creation of the local subscription 30S wireless communication network 30.

Regardless, based on receiving the request from the wireless communication equipment 10, wireless communication network 30 correspondingly transmits a request to wireless communication network 20 (Step 2). Wireless communication network 30 in this regard may simply forward or proxy the received request to wireless communication network 20, or may re-package information from the received request into a different request. Either way, the request to wireless communication network 20 may be a request for assistance with creating the subscription 30S to wireless communication network 30 on the basis of the subscription 20S to wireless communication network 20. Or, the request may be a request for subscription data 20D for the subscription 20S to wireless communication network 20.

In any event, the request as shown similarly includes an identifier (ID) that identifies the subscription 20S to wireless communication network 20. In embodiments where the request from the wireless communication equipment 10 includes such identifier, wireless communication network 30 may transmit the same identifier in its request to wireless communication network 20. In other embodiments, though, the request from the wireless communication equipment 10 does not include any such identifier. In this case, at least where wireless communication network 30 is a visited network for the subscription 20S, wireless communication network 30 may detect the identity of the subscription 20S from a context stored in wireless communication network 30 based on the previous attachment and registration of the wireless communication equipment 10 with wireless communication network 30.

In any event, responsive to receiving the request from wireless communication network 30, wireless communication network 20 checks whether the subscription data 20D* for the subscription 20S identified by the identifier (ID) is allowed to be used for creating a subscription 30S to wireless communication network 30 (Step 3). Wireless communication network 20 may perform this check, for example, based on a type of the subscription 20S to wireless communication network 20, a country or region of wireless communication network 30, and/or an identity or operator of wireless communication network 30. In one embodiment, for instance, the subscription data 20D* for the subscription 20S is allowed to be used for creating a subscription 30S to wireless communication network 30 only if (i) the subscription 20S is a pre-paid subscription, not a post-paid subscription; (ii) the country or region of wireless communication network 30 is included in a list of one or more allowed countries or regions; and/or (iii) the identity or operator of wireless communication network 30 is included in a list of one or more allowed network identities/operators. In these and other embodiments, then, wireless communication network 20 may perform the check based on an operator-specific policy and/or a profile-specific policy dictating whether or not the subscription 20S is allowed to be used for creating a subscription 30S to wireless communication network 30. Here, an operator-specific policy refers to a policy that a subscription can be created to only one or more certain operators/networks. And, a profile-specific policy refers to a policy that a subscription can be created only for one or more certain types of profiles, e.g., a profile that corresponds to a pre-paid subscription or a profile that is not owned by an enterprise.

If the subscription data 20D* for the subscription 20S is allowed to be used for creating a subscription 30S to wireless communication network 30 according to that check, wireless communication network 20 transmits that subscription data 20D* to wireless communication network 30 (Step 4). Wireless communication network 20 may do so for instance within a message that indicates such allowability and that requests wireless communication network 30 to create the subscription 30S. The message may additionally include, for instance, billing and profile policy rules to be used for creating the subscription 30S, an equipment identifier identifying the wireless communication equipment 10, and/or a subscription identifier identifying the subscription 20S.

Wireless communication network 30 correspondingly creates the subscription 30S based on the subscription data 20D* received from wireless communication network 20. As part of or after creating the subscription 30S, wireless communication network 30 initiates, controls, or otherwise facilitates provisioning of wireless communication network 30 and/or wireless communication equipment 10 so that the wireless communication equipment 10 can receive wireless communication service from wireless communication network 30 on the basis of the subscription 30S.

More particularly, in some embodiments, wireless communication network 30 transmits to wireless communication equipment 10 information indicating subscription plans available for the subscriber to choose between (Step 5). Each subscription plan may for instance define (i) one or more services to be provided under the subscription 30S to wireless communication network 30; and/or (ii) a billing policy according to which the subscription 30S to wireless communication network 30 is to be billed. Each subscription plan may be specified in terms of a plan identifier or name, pricing, use limitations, one or more connectivity types provided under the plan (e.g., 3G, 4G, 5G, etc.), a volume of data allowed in the uplink and/or downlink under the plan, a speed of data transfer allowed under the plan, a number of minutes usable under the plan for voice communication, a Short Message Service (SMS) number, charging rules, any billing discount applicable under the subscription, etc. In some embodiments, wireless communication network 30 limits the subscription plans available to those appropriate for a type of the wireless communication equipment 10, e.g., as determined from an equipment identifier of the wireless communication equipment 10. Regardless, wireless communication equipment 10 may correspondingly select from the available subscription plans, e.g., based on input from the user of wireless communication equipment 10 on which the available subscription plans are displayed and/or subject to acceptance of Terms & Conditions for the new subscription 30S to be created. The wireless communication equipment 10 may then transmit information indicating the selected subscription plan to be associated with the subscription 30S to wireless communication network 30 (Step 6). The wireless communication equipment 10 may do so within a request to create the subscription 30S according to the selected subscription plan. The request may for instance contain the equipment identifier for the wireless communication equipment 10 and an identifier of the selected subscription plan.

In other embodiments not shown, though, wireless communication network 30 is configured to create the subscription 30S according to a specific subscription plan (e.g., a default subscription plan). In this case, then, Steps 5 and 6 need not be performed.

Regardless of how wireless communication network 30 identifies the subscription plan according to which the subscription 30S is to be created, wireless communication network 30 next transmits, to SM-DP equipment 40, an order for a profile 30P for the subscription 30S to wireless communication network 30 (Step 7), as described previously with respect to FIG. 2. SM-DP equipment 40 generates the requested profile 30P and transmits to wireless communication network 30 a response that includes information associated with the subscription 30S (Step 8). As shown, this response may for example include a profile ID identifying the profile 30P and/or an activation code usable to retrieve the profile 30P from the SM-DP equipment 40.

Wireless communication network 30 as shown then forms the subscription data 30D for the subscription 30S based on the received subscription data 20D*. For example, wireless communication network 30 may include at least some of the received subscription data 20D* in the subscription data 30D for the subscription 30S to wireless communication network 30. In embodiments where the subscription data 30D is formed to include an identifier of, or pointer to, the subscription 20S to wireless communication network 20, this may effectively link or bind the subscriptions 20S, 30S together, e.g., so as to indirectly link or bind the created subscription 30S (and profile 30P) to the billing information and/or subscription identifier associated with the subscription 20S to wireless communication network 20. In any event, wireless communication network 30 stores the formed subscription data 30D in a subscription data store 32 for the wireless communication network 30.

Wireless communication network 30 also transmits, to wireless communication equipment 10, information associated with the created subscription 30S, e.g., within a message indicating successful creation of the subscription 30S (Step 10). As shown, this information includes the activation code received from the SM-DP equipment 40. In other embodiments not shown, though, the information need not include an activation code and may simply be an acknowledgement that the subscription 30S was created successfully. The wireless communication equipment 10 may thereafter retrieve the profile 30P associated with the subscription 30S using the activation code and configure the wireless communication equipment 10 with the retrieved profile 30P. In particular, the wireless communication equipment 10 as shown transmits a profile request to the SM-DP equipment 40 and includes the activation code in that request (Step 11). The SM-DP equipment 40 then transmits, to the wireless communication equipment 10, the profile 30P associated with the provided activation code (Step 12).

Note that Steps 1-2 in FIG. 3A may not be performed on other embodiments, though. For example, in some embodiments, wireless communication network 20 is configured to autonomously detect conditions under which the subscription data 20D* is usable to create a subscription 30S to wireless communication network 30. Wireless communication network 20 may for instance trigger creation of the subscription 30S responsive to detecting that the subscription 20 is roaming to wireless communication network 30, e.g., where such detection may be based on a context and state created during registration with wireless communication network 30.

By contrast, FIG. 3B illustrates another example where wireless communication network 20, rather than wireless communication network 30, interfaces with the wireless communication equipment 10 for creation of the subscription 30S. The description above for FIG. 3A applies equally to the description of FIG. 3B, with the exceptions below. As shown in this regard, the wireless communication equipment 10 transmits the request in Step 1 to wireless communication network 20 rather than to wireless communication network 30. The request as depicted in some embodiments includes not only the identifier for the subscription 20S (subscription ID) but also an identifier of wireless communication network 30 for which a subscription 30S is requested (network ID). Wireless communication network 20 correspondingly checks whether or not the subscription data 20D for the subscription 20 is allowed to be used to create a subscription 30S to wireless communication network 30 (Step 2), as described above with respect to FIG. 3B. If this is allowed, wireless communication network 20 requests information from wireless communication network 30 about the available subscription plans (Step 3). In some embodiments, wireless communication network 20 includes in the request an identity of wireless communication network 20 and/or an equipment identifier identifying wireless communication equipment 10, e.g., so that wireless communication network 30 can determine which subscription plans are available on a network by network basis and/or on an equipment by equipment basis. In any event, wireless communication network 20 receives the requested subscription plan information in response (Step 4). Wireless communication network 20 in turn transmits information about the available subscription plans to the wireless communication equipment 10 (Step 5), and receives information indicating the subscription plan selected by the wireless communication equipment 10 (Step 6). Wireless communication network 20 thereafter transmits, to wireless communication network 30, an order for a subscription 30S to wireless communication network 30 (Step 7). This order as shown includes a name or identifier of the subscription plan selected, and also includes the subscription data 20D* based on which the subscription 30S is to be created. In some embodiments, the order further includes an equipment identifier identifying the wireless communication equipment 10. In accordance with this order, wireless communication network 30 transmits, to the SM-DP equipment 40, an order for the profile 30P for the subscription 30S, e.g., where the order includes the selected subscription plan (Step 8). The process then proceeds as described above with respect to FIG. 3A, except that wireless communication network 30 relays the activation code to the wireless communication 10 equipment via wireless communication network 20.

Note that, in the embodiments shown in FIG. 3B, the wireless communication networks 20, 30 utilize a communication interface, connection, or channel between them, e.g., to communicate subscription data 20D*, available subscription plans, the subscriber-selected subscription plan, etc. In some embodiments, this communication interface, connection, or channel is trusted, authenticated, and/or secure, e.g., so that wireless communication network 30 is able to authenticate the request from wireless communication network 20 for the creation of a subscription 30S and/or so that wireless communication network 20 is able to authenticate the request from wireless communication network 30 for subscription data 20D*. In these and other embodiments, the communication interface, connection, or channel between wireless communication networks 20, 30 may be standardized and/or use a standardized application programming interface (API). This way, embodiments herein may be utilized by any wireless communication networks configured to communicate using such interface or API. Otherwise, in embodiments that utilize a non-standardized interface or API, wireless communication networks 20, 30 may communicate authenticated messages between them and providing corresponding capabilities for each received request.

No matter whether the approach of FIG. 3A or 3B is used, embodiments herein effectively provision wireless communication equipment's integrated circuit card 10C with the profile 30P for the created subscription 30S to wireless communication network 30. With the profile 30P configured and activated on the wireless communication equipment's integrated circuit card 10C, the wireless communication equipment 10 may receive wireless communication service from wireless communication network 30 according to the subscription 30S.

In some embodiments, the wireless communication equipment's integrated circuit card 10C is capable of having multiple profiles 20P, 30P activated at the same time, in which case the wireless communication equipment 10 may be able to receive wireless communication service from both wireless communication network's 20, 30 using the respective subscriptions 20S, 30S. In one such embodiment, for example, the wireless communication equipment 10 may use the subscription 30S to wireless communication network 30 for communication initiated by the wireless communication equipment 10 and for monitoring for communication initiated by wireless communication network 30, while at the same time using the subscription 20S to wireless communication network 20 for monitoring for communication initiated by wireless communication network 20. This may mean, for example, giving priority to the newly created subscription 30S to wireless communication network 30 for user-initiated communication, while using the original subscription 20S to wireless communication network 20 to listen to incoming communications such as phone calls made to the phone number associated with that subscription 20S. In this case, then, the subscriber may be reachable at the new phone number assigned by wireless communication network 30 while also still being reachable at the original phone number assigned by wireless communication network 20.

In other embodiments, though, the wireless communication equipment's integrated circuit card 10C is only capable of having a single one of the profiles 20P, 30P activated at a time. In this case, the wireless communication equipment 10 uses the subscription 30S to wireless communication network 30 for all communication. Accordingly, the subscriber may only be reachable at the new phone number assigned by wireless communication network 30. Nonetheless, according to some embodiments herein, wireless communication network 20 configures a call forwarding rule to forward calls made to the subscriber's original phone number (as assigned by wireless communication network 20) to the subscriber's new phone number (as assigned by wireless communication network 30).

Generally, then, in some embodiments, not only does wireless communication network 20 share subscription data 20D* with wireless communication network 30, but wireless communication network 30 in turn shares with wireless communication network 20 at least some of the subscription data 30D for the newly created subscription 30. That is, in some embodiments, wireless communication network 20 receives, from wireless communication network 30, subscription data 30D* for the newly created subscription 30 to wireless communication network 30. The subscription data 30D* may for instance include an identifier that identifies the integrated circuit card 10C or identifies the profile 30P for the new subscription 30S, e.g., in the form of an Integrated Circuit Card Identification Number (ICCID). Alternatively or additionally, the subscription data 30D* may include a confirmation code for the user to enter for authentication purposes and/or the activation code usable to retrieve the profile 30P, e.g., including a fully qualified domain name of the SM-DP equipment 40. In still other embodiments, the subscription data 30D* may include the subscriber's new phone number as assigned by wireless communication network 30, e.g., in the form of a Mobile Station International Subscriber Directory Number (MSIDSN) for the subscription 30S.

In these and other embodiments, wireless communication network 20 may use the received subscription data 30D* to configure billing and/or communication service for the subscription 20S to wireless communication network 20. For example, where the subscription data 30D* includes the MSIDSN for the subscription 30S, wireless communication network 20 may configure call forwarding from an MSIDSN for the subscription 20S to the MSIDSN for the subscription 30S, i.e., calls made to the MSIDSN for the subscription 20S will be forwarded to the MSIDSN for the subscription 30S.

Note that the wireless communication equipment 10 may communicate with wireless communication network 30 and/or the SM-DP equipment 40 using any available data connectivity. Such data connectivity may for example be provided by a local area network, e.g., using WiFi. Alternatively, the data connectivity may be provided using wireless communication network 30 on the basis of a roaming agreement with wireless communication network 20 and the subscription 20S to wireless communication network 20, i.e., roaming data connectivity. In fact, in some embodiments, roaming fees may be exempted or discounted when roaming data connectivity is used for creating a local subscription 30S to wireless communication network 30, e.g., as the data connectivity is being used for onboarding a new subscriber which will generate revenue.

In some embodiments, though, the wireless communication equipment 10 has been configured by the user to prohibit data from being transmitted to or from the wireless communication equipment 10 via roaming data connectivity, e.g., a packet switched (PS) data parameter may be set to ‘off’. Some embodiments nonetheless exempt from this prohibition communication for the purpose of creating the subscription 30S to wireless communication network 30, i.e., such communication is exempt from the prohibition on roaming data connectivity. For example, the profile 30P may be downloaded free of charge. In one embodiment, for example, the wireless communication equipment 10 includes subscription creation in a list of one or more services exempt from the prohibition on roaming data connectivity. In such a case, the wireless communication equipment 10 may communicate this list to one or both of the wireless communication networks 20, 30, so that the network(s) 20, 30 know that subscription creation is exempt. Note, though, in some embodiments there may be one exemption list for wireless communication network 20 and another exemption list for wireless communication network 30.

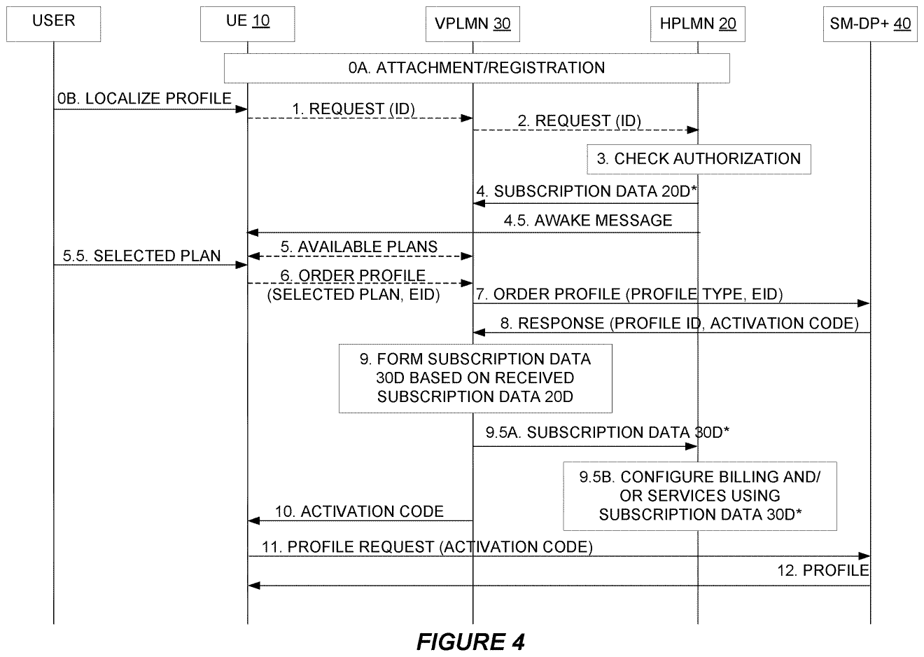

FIG. 4 illustrates additional details of some embodiments herein in an example context where wireless communication equipment 10 is a user equipment (UE) and, according to the subscription 20S, wireless communication network 20 is a Home Public Land Mobile Network (HPLMN) and wireless communication network 30 is a Visited PLMN (VPLMN). Additionally, SM-DP equipment 40 is exemplified as SM-DP+. Furthermore, although not shown, the VPLMN 30 and/or HPLMN 20 may each implement a localization service, e.g., where the localization service is a service for creating the local subscription 30S to the VPLMN 30 based on the subscription data 20D* for the HPLMN subscription 20S. Alternatively or additionally, the UE 10 may execute a localization application, e.g., with a user interface via which the user may trigger creation of the local subscription 30S and/or interact with the localization service at the VPLMN 30 and/or HPLMN 20. Steps in FIG. 4 correspond to the same numbered steps in FIG. 3A. In this example context, the user of UE 10 roams to the VPLMN 30. Both the HPLMN 20 and the VPLMN 30 are aware of this when the UE 10 attaches and registers through the VPLMN 30 (Step 0A). In some embodiments, the user triggers the localization service in the VPLMN 30 to create a subscription 30S to the VPLMN 30 from the HPLMN subscription 20S, e.g., using the localization application which uses the localization service of the VPLMN 30 to order a new profile 30P for a subscription 30S to the VPLMN 30 (Step OB). Alternatively, the UE 10 is configured to automatically trigger the localization service in the VPLMN 30 to create the subscription 30S when roaming to VPLMN 30, in which case the user does not need to trigger this.

Steps 1-4 correspond to Steps 1-4 from FIG. 3A. In particular, the UE 10 contacts the localization service in the VPLMN 30, requesting subscription/profile localization from the HPLMN 20 to the VPLMN 30 (Step 1). The localization service in the VPLMN 30 learns the identity of the HPLMN subscription 20S, either from an ID included in the request transmitted by the UE 10 or from a context stored in the VPLMN 30 for the UE 10. The localization service in the VPLMN 30 correspondingly contacts or proxies the request to the peer localization service in the HPLMN 20 (Step 2). The localization service in the HPLMN 20 checks whether or not the HPLMN subscription data 20D is allowed to be used for creating a subscription 30S to the VPLMN 30 (Step 3). If so, the localization service in the HPLMN 20 sends, to the localization service in the VPLMN 30, a message that indicates localization is acceptable, that includes subscription data 20D* for the HPLMN 20, and that requests the localization service in the VPLMN 30 to configure the corresponding network policy and SIM profile policy for the user and the UE 10 to use the subscription 30S to the VPLMN 30 (Step 4).

As shown, the localization service in the HPLMN 20 next triggers the localization application at the UE 10 to proceed with the localization procedure. For example, the localization service in the HPLMN 20 may send an SMS to the UE's localization application to wake the localization application up and to connect to a particular server in the VPLMN 30 (for which the information is provided over SMS) (Step 4.5). Alternatively, the localization service in the HPLMN 20 may trigger the localization procedure by sending a push notification or a response to the request from Step 2.

Note here, though, that SMS may be used by the HPLMN 20 to, for example, direct further messages of the UE's localization application to a specific service in the HPLMN 20, e.g., for further verification before allowing subscription localization. If this is needed, it would take place before Step 4. Note further that the localization service in the VPLMN 30 may send a response to the request received in Step 1, indicating whether or not subscription localization is allowed. Both the HPLMN and VPLMN localization service in some embodiments sends a message to the UE's localization application, to get further verification that subscription localization is allowed.

In any event, the UE's localization application next communicates with the specific server in the VPLMN 30 indicated in Step 4.5, to get subscription plans available to the user for a subscription 30S to the VPLMN 30 (Step 5). The available subscription plans are displayed to the user by the UE's localization application. The user selects one of the available subscription plans (Step 5.5), and accepts the Terms & Conditions for the new subscription 30S.

Correspondingly, the UE's localization application requests the specific server in the VPLMN 30 to order the profile 30P for the new subscription 30S to the VPLMN 30 (Step 6). The request may contain the selected subscription plan and the equipment identifier for the UE 10.

The request in Step 6 may be sent over an authenticated connection between the UE 10 and the specific service in the VPLMN 30. This may be done using a mutual authentication procedure defined for eSIM, i.e. using an EID-based identity and certificate. Otherwise, the request may be otherwise bound to the UE/subscription in the HPLMN 20. For example both the VPLMN 30 and the UE 10 may receive a code from the HPLMN 20 in Steps 4 and 4.5 respectively. Using the code, the UE 10 may be authorized as a valid profile requester to the VPLMN 30. Note that this step may be proxied through the HPLMN 20, as the localization application in the UE 10 may not be able to authenticate itself to the VPLMN 30.

In any event, upon receiving the order in Step 6, the VPLMN 30 starts preparing the subscription 30 for the particular eSIM device and makes an order for the profile 30P for subscription 30S from a chosen SM-DP+ server 40 (Step 7). The SM-DP+ server 40 creates the profile 30P and indicates that the profile 30P is available (Step 8). Upon receiving the response from the SM-DP+ server 40, the VPLMN 30 forms the subscription data 30D for the subscription 30 based on the subscription data 20D* for the subscription 20 (Step 9). In doing so, the VPLMN 30 directly or indirectly links billing information from the HPLMN subscription data 20D* with the subscription 30S to the VPLMN 30. The VPLMN 30 provisions the VPLMN 30 with the formed subscription data 30D, e.g., by storing it in a UDM for the VPLMN 30.

The VPLMN 30 in some embodiments informs the HPLMN 20 of at least some of the formed subscription data 30D* (Step 9.5A). Based on this subscription data 30D*, the HPLMN 20 may update its billing and/or network service, e.g., to forward calls from the subscription 20S in the HPLMN 20 to the subscription 30S in the VPLMN 30 (Step 9.5B). Although not shown, the HPLMN 20 may transmit an acknowledgement to the VPLMN 30 upon successfully updating the HPLMN's billing and/or network service.

Steps 10-12 proceed as described with respect to FIG. 3A. In particular, the VPLMN 30 informs the UE 10 about the success of the order for profile 30P and provides the UE 10 with information needed to download the new profile 30P (Step 10). The UE 10 correspondingly requests and downloads the new profile 30P from the SM-DP+ server 40, e.g., using available data connectivity (Steps 11-12).

Note that Steps 4.5 through 6 in FIG. 4 may be accomplished in any number of ways. As an alternative to the way shown, the HPLMN 20 may send available subscription plans to the user via an SMS message directly, e.g., in the case no roaming data connectivity exists. Or, an SMS with a link to the available subscription plans may be sent to the user for selection therebetween.

In yet other embodiments, the VPLMN 30 is the network that awakes the UE's localization application (e.g., upon attachment), rather than the HPLMN 20 as shown in Step 4.5. In these and other embodiments, though, the HPLMN 20 may send an SMS to the UE 10 indicating a URL at which the user can login using security credentials (e.g., bank codes) and approve initiation of the localization procedure. Or, the user may respond to the SMS indicating such approval.

As an alternative, the VPLMN 30 may not initiate contact with the HPLMN 20. In this case, the VPLMN 30 provides the available subscription plans to the user (e.g., over SMS), with each subscription plan containing a code that identifies the plan and VPLMN 30. The user may then send the code to the HPLMN 20, e.g., using SMS, as a trigger for the HPLMN 20 to start the localization procedure.

Generally, then, according to some embodiments herein a user is offered to use his or her home subscription 20S to activate a local subscription 30S of a roaming partner of its home operator. That is, the home subscription can be used to generate a corresponding local subscription 30S in the roaming operator network 30. Especially in such a case where the home operator already has a roaming agreement with the roaming operator, such agreement may be extended to cover remote subscription management between parties. Such agreement may be applied in one or both directions between the parties. Moreover, all customer information and billing information may be retained in the home network for privacy. Or, if permitted by the customer, the customer and billing information can be transferred to the chosen/available roaming operator to build the local subscription 30S.

Some embodiments may thereby prove advantageous for enabling a user to conveniently get a local subscription to a wireless communication network, e.g., without having to go to a point-of-sale of the network operator. This will greatly reduce the complexity of a traveler and also boost the value of an operator that provides this service with respect to numerous partner operators. Additionally, some embodiments do so while preserving the privacy of the user, e.g., since the user does not have to provide any information to the partner roaming network to create a local subscription. Alternatively or additionally, some embodiments ease the burden of identifying roaming subscribers, e.g., since identifying a roaming user takes much longer than identifying a regular user. Alternatively or additionally, some embodiments better optimize network performance as user traffic need not be routed to the home network (e.g., in a different country).

Note that although some embodiments above have exemplified the subscription localization process as being triggered from the wireless communication equipment 10 itself, such need not be the case. In fact, any communication equipment, whether wireless communication equipment 10 or otherwise, may trigger the process provided the communication equipment is authorized to do so. Generally, then, communication equipment herein may transmit a request that subscription data 20D* for the subscription 20S to wireless communication network 20 be used for creating a subscription 30S to wireless communication network 30.

Consider a simple example where a subscriber desires to configure his or her UE with the profile 30D for the subscription 30S even before the subscriber arrives in the coverage area of wireless communication network 30 (or even before the subscriber roams away from the coverage area of wireless communication network 20). In this case, the subscriber may still trigger creation of the subscription 30. For example, the subscriber may log into an online portal provided by wireless communication network 20. After appropriate authentication (e.g., username/password based, bank identification based, etc.), the subscriber chooses another wireless communication network 30 for which to create a subscription 30S. This wireless communication network 30 may for instance be a roaming partner in a foreign country. In any event, in the portal the subscriber is presented with options to choose between available subscription plans for the subscription 30S. Upon selection of a subscription plan, the wireless communication network 20 sends an order for the creation of the subscription 30S according to the selected subscription plan.

Accordingly, in some embodiments the subscription 30S is purchased prior to roaming but activated upon arrival in wireless communication network 30. Or, in other embodiments, the subscription 30S is purchased on demand upon arrival in wireless communication network 30, e.g., after presenting different options to the user.

Note further that although some embodiments herein have been exemplified in a context where wireless communication networks 20, 30 are roaming partners with a roaming agreement, such need not be the case.

Note further still that some embodiments herein exploit eSIM based technologies, e.g., as defined by GSMA SGP.22—RSP Technical specification, V2.2.2.

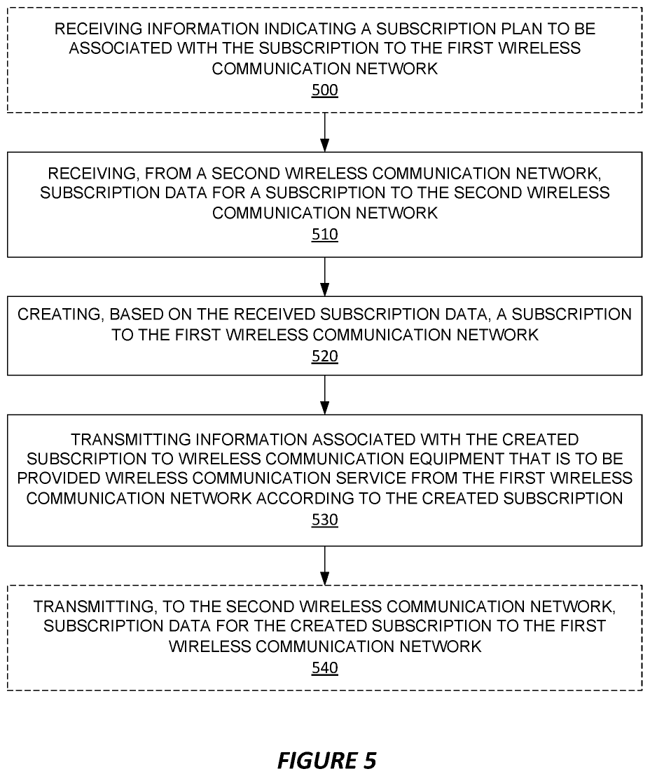

In view of the modifications and variations herein, consider various embodiments generalized with reference to wireless communication network 30 as a first wireless communication network 30 and wireless communication network 20 as a second wireless communication network 20. In this regard, FIG. 5 illustrates a method performed by network equipment 34 in a first wireless communication network 30. The method comprises receiving, from a second wireless communication network 20, subscription data 20D* for a subscription 20S to the second wireless communication network 20 (Block 510). The method further comprises creating, based on the received subscription data 20D*, a subscription 30S to the first wireless communication network 30 (Block 520).

In some embodiments, the method further comprises receiving information indicating a subscription plan to be associated with the subscription 30S to the first wireless communication network 30 (Block 500). In this case, creation of the subscription 30S may be performed according to the indicated subscription plan.

Regardless, in some embodiments, the method also comprises transmitting information 44 associated with the created subscription 30S to wireless communication equipment 10 that is to be provided wireless communication service from the first wireless communication network 30 according to the created subscription 30S (Block 530). The information 44 may for instance include an activation code or other information usable to retrieve a subscription profile 30P for the created subscription 30S.

In some embodiments, the method also comprises transmitting, to the second wireless communication network 20, subscription data 30D* for the created subscription 30S to the first wireless communication network 30 (Block 540).

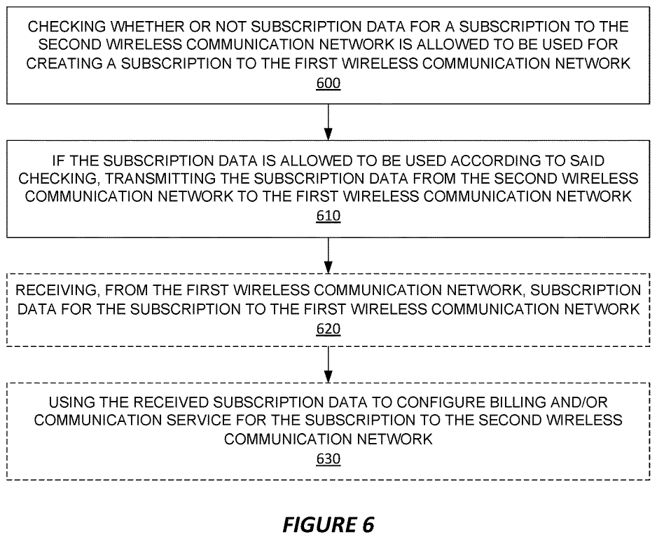

FIG. 6 illustrates a corresponding method for assisting a first wireless communication network 30 with subscription management. The method is performed by network equipment 24 in a second wireless communication network 20. The method as shown comprises checking whether or not subscription data 20D* for a subscription 20S to the second wireless communication network 20 is allowed to be used for creating a subscription 30S to the first wireless communication network 30 (Block 600). The method further comprises, if the subscription data 20D* is allowed to be used according to that checking, transmitting the subscription data 20D* from the second wireless communication network 20 to the first wireless communication network 30 (Block 610).

In some embodiments, the method also comprises receiving, from the first wireless communication network 30, subscription data 30D* for the subscription 30S to the first wireless communication network 30 (Block 620). In this case, the method may further comprise using the received subscription data 30D* to configure billing and/or communication service for the subscription 20S to the second wireless communication network 20 (Block 630).

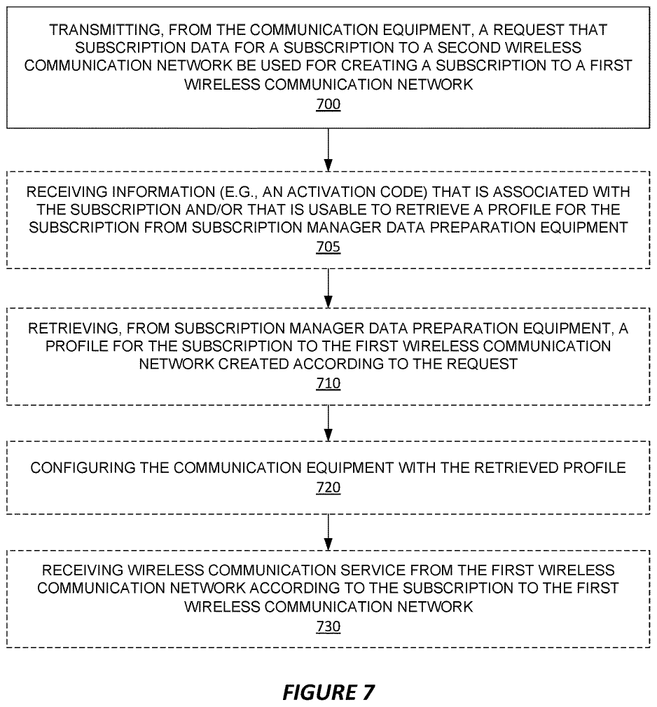

FIG. 7 illustrates a method performed by communication equipment 800, e.g., wireless communication equipment 10 or some other communication equipment. The method comprises transmitting, from the communication equipment 800, a request that subscription data 20D* for a subscription 20S to a second wireless communication network 20 be used for creating a subscription 30S to a first wireless communication network 30 (Block 700).

In some embodiments, the method further comprises receiving information (e.g., an activation code) that is associated with the subscription 30S and/or that is usable to retrieve a profile 30P for the subscription 30S from subscription manager data preparation equipment 40 (Block 705).

In some embodiments, the method further comprises retrieving, from subscription manager data preparation equipment 40, a profile 30P for the subscription 30S to the first wireless communication network 30 created according to the request (Block 710). In this case, the method may also comprise configuring the communication equipment 800 with the retrieved profile 30P (Block 720).

In some embodiments, the method further comprises receiving wireless communication service from the first wireless communication network 30 according to the subscription 30S to the first wireless communication network 30 (Block 730).

Embodiments herein also include corresponding apparatuses. Embodiments herein for instance include communication equipment 800 configured to perform any of the steps of any of the embodiments described above for the communication equipment 800.

Embodiments also include communication equipment 800 comprising processing circuitry and power supply circuitry. The processing circuitry is configured to perform any of the steps of any of the embodiments described above for the communication equipment 800. The power supply circuitry is configured to supply power to the communication equipment 800.

Embodiments further include communication equipment 800 comprising processing circuitry. The processing circuitry is configured to perform any of the steps of any of the embodiments described above for the communication equipment 800. In some embodiments, the communication equipment 800 further comprises communication circuitry.

Embodiments further include communication equipment 800comprising processing circuitry and memory. The memory contains instructions executable by the processing circuitry whereby the communication equipment 800 is configured to perform any of the steps of any of the embodiments described above for the communication equipment 800.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication equipment 800. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include network equipment 24, 34 configured to perform any of the steps of any of the embodiments described above for the network equipment 24, 34.

Embodiments also include network equipment 24, 34 comprising processing circuitry and power supply circuitry. The processing circuitry is configured to perform any of the steps of any of the embodiments described above for the network equipment 24, 34. The power supply circuitry is configured to supply power to the network equipment 24, 34.

Embodiments further include network equipment 24, 34 comprising processing circuitry. The processing circuitry is configured to perform any of the steps of any of the embodiments described above for the network equipment 24, 34. In some embodiments, the network equipment 24, 34 further comprises communication circuitry.

Embodiments further include network equipment 24, 34 comprising processing circuitry and memory. The memory contains instructions executable by the processing circuitry whereby the network equipment 24, 34 is configured to perform any of the steps of any of the embodiments described above for the network equipment 24, 34.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

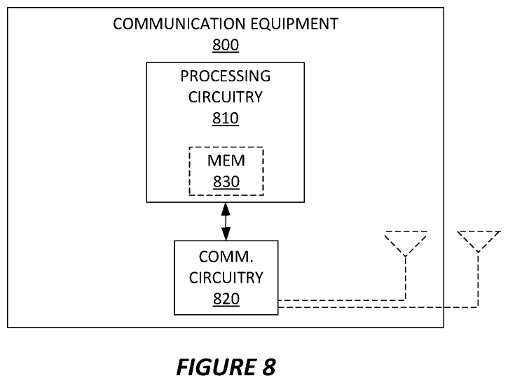

FIG. 8 for example illustrates communication equipment 800 (e.g., wireless communication equipment 10) as implemented in accordance with one or more embodiments. As shown, the communication equipment 800 includes processing circuitry 810 and communication circuitry 820. The communication circuitry 820 (e.g., radio circuitry) is configured to transmit and/or receive information to and/or from one or more other nodes, e.g., via any communication technology. Such communication may occur via one or more antennas that are either internal or external to the communication equipment 800. The processing circuitry 810 is configured to perform processing described above, e.g., in FIG. 7, such as by executing instructions stored in memory 830. The processing circuitry 810 in this regard may implement certain functional means, units, or modules.

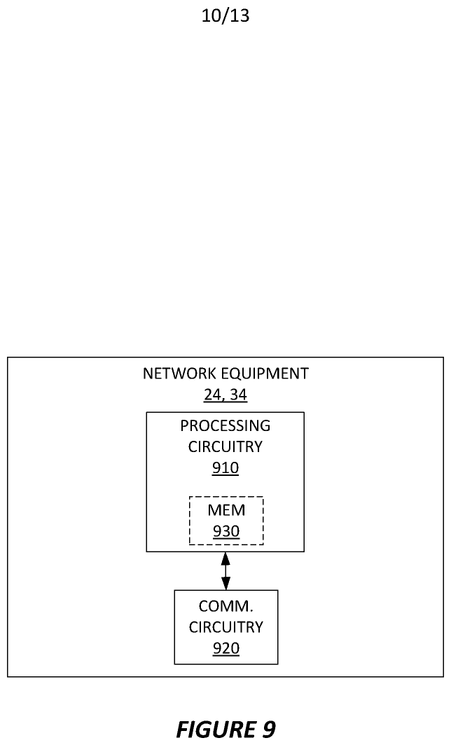

FIG. 9 illustrates network equipment 24, 34 as implemented in accordance with one or more embodiments. As shown, the network equipment 24, 34 includes processing circuitry 910 and communication circuitry 920. The communication circuitry 920 is configured to transmit and/or receive information to and/or from one or more other nodes, e.g., via any communication technology. The processing circuitry 910 is configured to perform processing described above, e.g., in FIG. 5 and/or FIG. 6, such as by executing instructions stored in memory 930. The processing circuitry 910 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

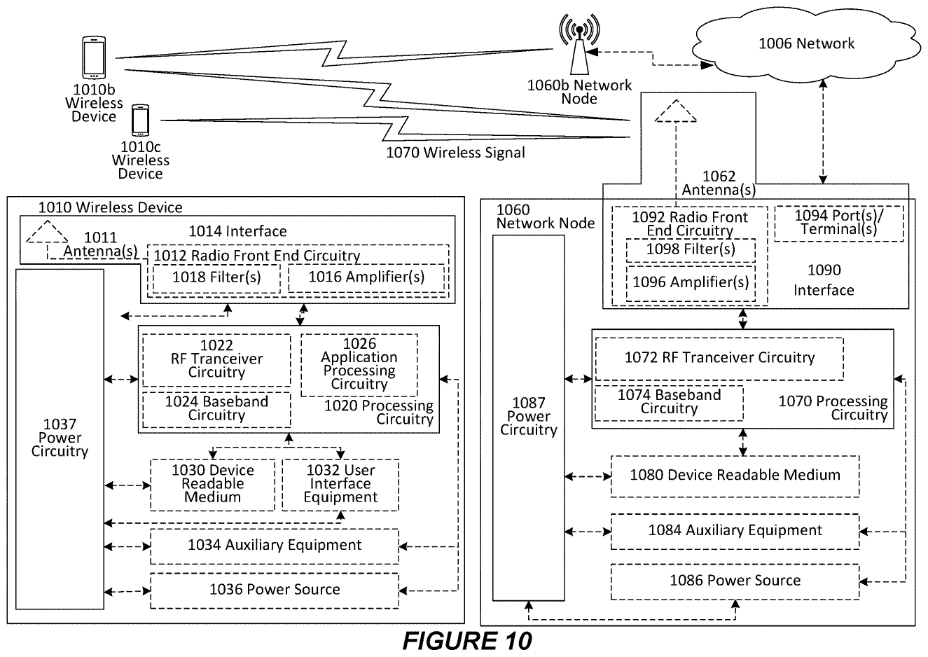

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network 1006, network nodes 1060 and 1060b, and WDs 1010, 1010b, and 1010c. In practice, a wireless network may further include any additional elements suitable to support communication between wireless devices or between a wireless device and another communication device, such as a landline telephone, a service provider, or any other network node or end device. Of the illustrated components, network node 1060 and wireless device (WD) 1010 are depicted with additional detail. The wireless network may provide communication and other types of services to one or more wireless devices to facilitate the wireless devices'access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IOT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs).

Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, eNB or other such network device may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signalling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 10 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VolP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (loT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE, NR, WiFi, WiMAX, NB-IOT, or Bluetooth wireless technologies, just to mention a few. These wireless technologies may be integrated into the same or different chips or set of chips as other components within WD 1010.

Antenna 1011 may include one or more antennas or antenna arrays, configured to send and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

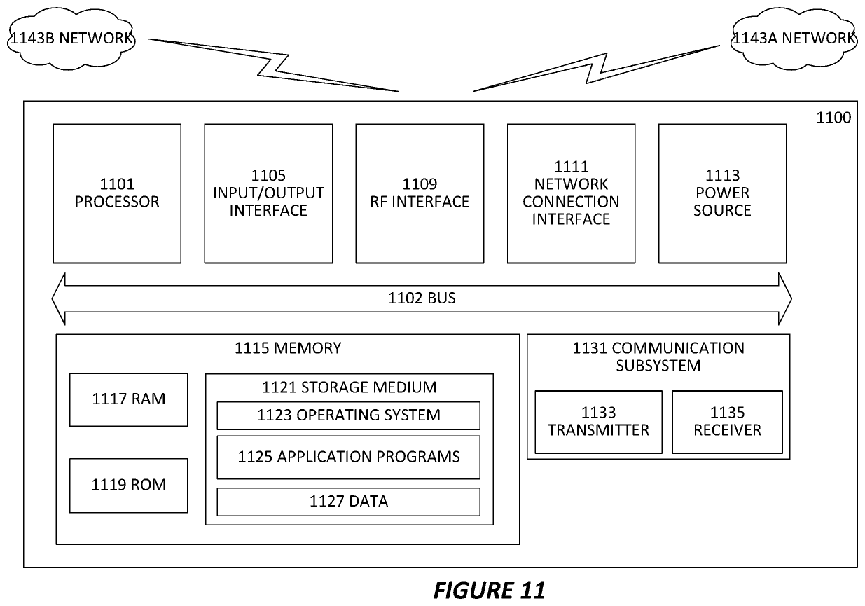

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 11200 may be any UE identified by the 3rd Generation Partnership Project (3GPP), including a NB-IOT UE, a machine type communication (MTC) UE, and/or an enhanced MTC (eMTC) UE. UE 1100, as illustrated in FIG. 11, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 11, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

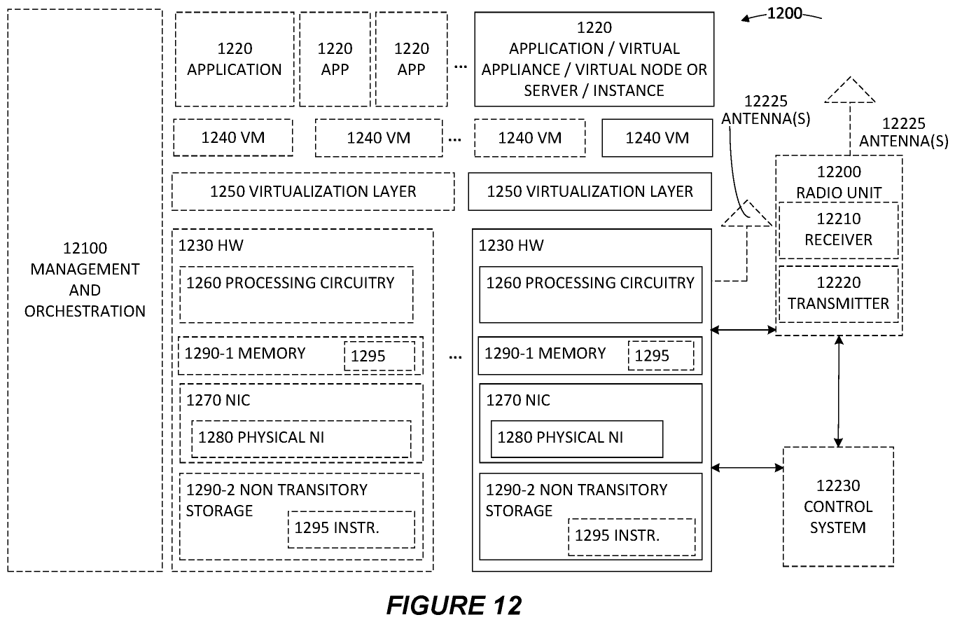

FIG. 12 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290. Memory 1290 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 12, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signalling can be effected with the use of control system 12230 which may alternatively be used for communication between the hardware nodes 1230 and radio units 12200.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1.-43. (canceled)

44. A method performed by network equipment in a first wireless communication network, the method comprising:
receiving, from a second wireless communication network, subscription data for a subscription to the second wireless communication network;
creating, based on the received subscription data, a subscription to the first wireless communication network; and
transmitting information associated with the created subscription to wireless communication equipment that is to be provided wireless communication service from the first wireless communication network according to the created subscription.

45. The method of claim 44, wherein, according to the subscription to the second wireless communication network, the second wireless communication network is a home network and the first wireless communication network is a visited network.

46. The method of claim 44, wherein the subscription data includes:
an equipment identifier that identifies the wireless communication equipment; and/or
an identifier of, or a pointer to, the subscription to the second wireless communication network.

47. The method of claim 44, wherein the subscription data excludes personally identifiable information of a subscriber that owns the subscription to the second wireless communication network, wherein the personally identifiable information includes:
billing information usable to directly bill a subscriber for the subscription to the second wireless communication network; and/or
a name of and/or address of a subscriber that owns the subscription to the second wireless communication network.

48. The method of claim 44, wherein said creating comprises forming subscription data for the subscription to the first wireless communication network and storing the formed subscription data in a subscription data store for the first wireless communication network, wherein the subscription data for the subscription to the first wireless communication network includes at least some of the received subscription data for the subscription to the second wireless communication network.

49. The method of claim 44, wherein said creating comprises transmitting, to subscription manager data preparation equipment, an order for a profile for the subscription to the first wireless communication network, wherein the information associated with the created subscription includes information usable to retrieve the profile from the subscription manager data preparation equipment.

50. The method of claim 44, further comprising receiving information indicating a subscription plan to be associated with the subscription to the first wireless communication network, wherein the subscription plan defines one or more of:
one or more services to be provided under the subscription to the first wireless communication network; and
a billing policy according to which the subscription to the first wireless communication network is to be billed;
wherein the subscription to the first wireless communication network is created according to the indicated subscription plan.

51. The method of claim 44, further comprising transmitting a request from the network equipment in the first wireless communication network to the second wireless communication network, wherein the request is a request for the subscription data for the subscription to the second wireless communication network or is a request for assistance with creating the subscription to the first wireless communication network, wherein the request includes a subscription identifier that identifies the subscription to the second wireless communication network, and wherein the subscription data for the subscription to the second wireless communication network is received in response to transmitting the request.

52. A method for assisting a first wireless communication network with subscription management, the method performed by network equipment in a second wireless communication network, the method comprising:
checking whether or not subscription data for a subscription to the second wireless communication network is allowed to be used for creating a subscription to the first wireless communication network; and
if the subscription data is allowed to be used according to said checking, transmitting the subscription data from the second wireless communication network to the first wireless communication network.

53. The method of claim 52, wherein the second wireless communication network is a home network for the subscription to the second wireless communication network, and wherein the first wireless communication network is a visited network for the subscription to the second wireless communication network.

54. The method of claim 52, wherein the subscription data includes:
an equipment identifier that identifies the communication equipment; and/or
an identifier of, or a pointer to, the subscription to the second wireless communication network.

55. The method of claim 52, wherein the subscription data excludes personally identifiable information of a subscriber that owns the subscription to the second wireless communication network, wherein the personally identifiable information includes:
billing information usable to directly bill a subscriber for the subscription to the second wireless communication network; and/or
a name of and/or address of a subscriber that owns the subscription to the second wireless communication network.

56. The method of claim 52, further comprising:
receiving, from the first wireless communication network, subscription data for the subscription to the first wireless communication network; and
using the received subscription data to configure billing and/or communication service for the subscription to the second wireless communication network.

57. The method of claim 56, wherein the received subscription data includes a Mobile Station International Subscriber Directory Number, MSIDSN, for the subscription to the first wireless communication network, and wherein said using comprises configuring call forwarding from an MSIDSN for the subscription to the second wireless communication network to the MSIDSN for the subscription to the first wireless communication network.

58. The method of claim 52, further comprising receiving a request that is either a request for the subscription data for the subscription to the second wireless communication network or a request for assistance with creating the subscription to the first wireless communication network, wherein the request includes a subscription identifier that identifies the subscription to the second wireless communication network, wherein said checking is performed responsive to receipt of the request.

59. The method of claim 52, further comprising:
receiving, from communication equipment associated with the subscription to the second wireless communication network, information indicating a subscription plan to be associated with the subscription to the first wireless communication network, wherein the subscription plan defines one or more of:
one or more services provided under the subscription to the first wireless communication network; and
a billing policy according to which the subscription to the first wireless communication network is billed; and
transmitting the received information to the first wireless communication network.

60. A method performed by communication equipment, the method comprising:
transmitting, from the communication equipment, a request that subscription data for a subscription to a second wireless communication network be used for creating a subscription to a first wireless communication network.

61. The method of claim 60, further comprising retrieving, from subscription manager data preparation equipment, a profile for the subscription to the first wireless communication network created according to the request and configuring the communication equipment with the retrieved profile.

62. The method of claim 60, further comprising:
transmitting, from the communication equipment to the first wireless communication network or to the second wireless communication network, information indicating a subscription plan to be associated with the subscription to the first wireless communication network, wherein the subscription plan defines one or more of:
one or more services provided under the subscription to the first wireless communication network; and
a billing policy according to which the subscription to the first wireless communication network is billed.

63. Communication equipment comprising:
communication circuitry; and
processing circuitry configured to transmit, from the communication equipment, a request that subscription data for a subscription to a second wireless communication network be used for creating a subscription to a first wireless communication network.
